(19) United States
(12) Patent Application Publication
(10) Pub. No.: US 2016/0371154 A1
(43) Pub. Date: Dec. 22, 2016

(54) REMOTE CONTROL DEVICE AND CONTROL SYSTEM

(71) Applicant: MITSUBISHI ELECTRIC CORPORATION, Tokyo (JP)

(72) Inventor: Yuji MAKIMOTO, Aichi (JP)

(73) Assignee: Mitsubishi Electric Corporation, Tokyo (JP)

(21) Appl. No.: 14/896,428

(22) PCT Filed: Nov. 5, 2014
(86) PCT No.: PCT/JP2014/079357

§ 371 Date: Dec. 7, 2015

(51) Int. Cl. G06F 11/14; H04L 29/08

(52) U.S. Cl. CPC G06F 11/1461; G06F 11/1448; H04L 67/125; G06F 2201/80

(57) ABSTRACT

A remote control device includes, in one housing: a communication functional unit that communicates with a programmable controller; an input/output functional unit that outputs control-target-device control information for controlling an operation of a control target device to the control target device on the basis of remote-control-device control information, which is output from the programmable controller and is used for controlling the remote control device, and to which operation result information, which is output from the control target device and indicates an operation result of the control target device that operates on the basis of the remote-control-device control information, is input; a backup managing unit that creates backup data for internal data stored in the remote control device; and a nonvolatile memory that stores the backup data.

### FIELD

The present invention relates to a remote control device that controls a control target device on the basis of control performed by a communicatively connected control device and a control system.

### BACKGROUND

Remote control devices have been developed that are used for controlling control target devices installed at positions remote from programmable controllers (programmable logic controllers: PLCs) and for capturing input from the sensors of the control target devices. The remote control devices are required to be small in size and low in cost in view of the application and the use environment. Thus, the remote control devices only have limited functions, i.e., an input/output function necessary for controlling the control target devices and for capturing input from the control target devices; and a communication function of performing data transmission and reception to and from the programmable controllers, and the remote control devices operate in accordance with instructions from the programmable controllers.

For the remote control devices, a system has been developed that backs up, in preparation for a failure or relocation to a different control system, internal data, such as setting data for setting the operations of the remote control devices. However, it has been necessary to use an instruction from the programmable controller as a trigger condition to back up internal data stored in the remote control devices. Moreover, it has been necessary to transmit data to be backed up to the programmable controller and store the data in the programmable controller. Thus, the programmable controller needs to manage backup data for all the remote control devices connected to the programmable controller via a computer network communication line; therefore, there is a problem in that management of backup data becomes complicated. Hereinafter, the computer network communication line is referred to as a network.

To monitor backup date and time at which internal data stored in the remote control device was backed up and regularly back up the internal data, it is necessary to construct a backup function by using a dedicated ladder program in the programmable controller and manage the backup date and time. Thus, there is a problem in that man-hours are required to create the ladder program for backup.

With respect to such a problem, for example, a technology is proposed in Patent Literature 1 in which a remote terminal device, which includes a communication unit and an input/output unit connected via a serial bus line, manages backup data in the communication unit by storing the backup data for the devices that are connected via a serial bus in the communication unit.

Moreover, for example, a technology is proposed in Patent Literature 2 with which, in the programmable controller, backup data for a ladder program and backup time are managed as a set and data with which a restore is performed can be selected on the basis of the backup time.

### CITATION LIST

### Patent Literature

Patent Literature 1: Japanese Patent Application Laid-open No. 2007-102764

Patent Literature 2: Japanese Patent Application Laid-open No. 2006-330866

### SUMMARY

### Technical Problem

However, with the technology in Patent Literature 1, the input/output unit, which is a functional unit that performs a backup, and the communication unit, which stores backup data, are configured as separate devices. Thus, there is a problem in that, when the communication unit is replaced, the backup data needs to be saved in a different device, such as a programmable controller.

Moreover, the technology in Patent Literature 2 is a technology for a programmable controller with which it is assumed that a ladder program is used; therefore, there is a problem in that this technology cannot be applied to devices with less resources such as remote control devices.

The present invention has been achieved in view of the above and an object of the present invention is to provide a remote control device that can manage backup data for internal data by itself and with which internal data is easily managed when the remote control device is relocated.

### Solution to Problem

In order to solve the above problems and achieve the object, an aspect of the present invention is a remote control device that is communicatively connected to a control device and a control target device and controls an operation of the control target device in accordance with a control performed by the control device, the remote control device including, in one housing: a communication functional unit that communicates with the control device; an input/output functional unit that outputs control-target-device control information for controlling an operation of the control target device to the control target device on a basis of remote-control-device control information, which is output from the control device and is used for controlling the remote control device, and to which operation result information, which is output from the control target device and indicates an operation result of the control target device that operates on a basis of the remote-control-device control information, is input; a backup managing unit that creates backup data for internal data stored in the remote control device; and a nonvolatile storage unit that stores the backup data.

### Advantageous Effects of Invention

The remote control device according to the present invention has an effect in that backup data for internal data can be managed by itself and internal data is easily managed when the remote control device is relocated.

### BRIEF DESCRIPTION OF DRAWINGS

FIG. 1 is a block diagram illustrating the configuration of a programmable controller system according to an embodiment of the present invention.

FIG. 2 is a block diagram illustrating the configurations of a programmable controller and a remote control device in the programmable controller system according to the embodiment of the present invention.

FIG. 3 is a schematic diagram illustrating one example of an association between backup data and backup history data in the programmable controller system according to the embodiment of the present invention.

FIG. 4 is a flowchart describing the operation of the backup process performed by a backup managing unit of the remote control device according to the embodiment of the present invention.

FIG. 5 is a diagram explaining the relocation of the remote control device according to the embodiment of the present invention.

FIG. 6 is a block diagram schematically illustrating an example of the configuration of a computer device that can realize functions as the programmable controller and the remote control devices according to the embodiment of the present invention.

### DESCRIPTION OF EMBODIMENTS

A remote control device and a control system according to embodiments of the present invention will be explained below in detail with reference to the drawings. This invention is not limited to the embodiments.

### Embodiment

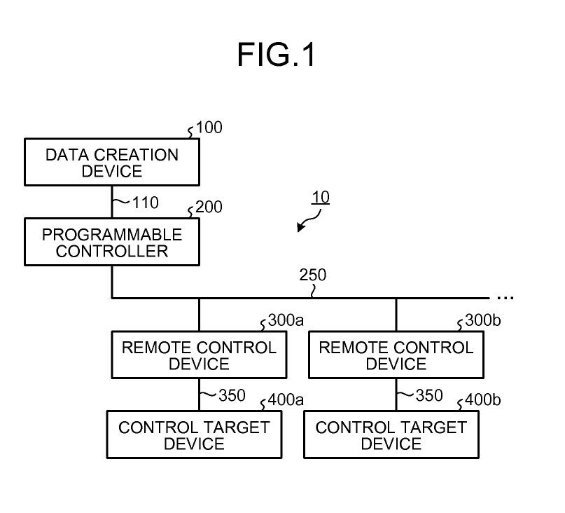

FIG. 1 is a block diagram illustrating the configuration of a programmable controller system 10, which is a control system, according to an embodiment of the present invention. The programmable controller system 10 is a control system that can control a plurality of control target devices disposed at positions remote from a programmable controller, which is a control device. The programmable controller system 10 includes control target devices 400a and 400b, which are to be controlled; a programmable controller 200, which is a control device; and remote control devices 300a and 300b, which control operations of the control target devices 400a and 400b in accordance with control from the programmable controller 200. Hereinafter, the remote control devices 300a and 300b are collectively referred to as remote control devices 300 in some cases. The control target devices 400a and 400b are collectively referred to as control target devices 400 in some cases. A data creation device 100 is connected to the programmable controller 200. The data creation device 100 can create or edit a ladder program, which is a control program used in the programmable controller 200, and various pieces of instruction information.

The data creation device 100 is communicatively connected to the programmable controller 200 by a communication line 110. The data creation device 100 creates or edits, in response to the operations by the user, a control program for the programmable controller 200 to cause the remote control devices 300 to control the control target devices 400 and various pieces of instruction information. The data creation device 100 provides the created or edited control program or various pieces of instruction information to the programmable controller 200 via the communication line 110. The control program for controlling the control target devices 400 is created as a ladder program in a ladder language. The data creation device 100 can create various pieces of instruction information indicating processes performed by the programmable controller 200 and the remote control devices 300 and input them into the programmable controller 200. A personal computer is, for example, used as the data creation device 100.

The programmable controller 200, which is a master station, is connected to a plurality of the remote control devices 300 by a network and controls the operations of the control target devices 400 and acquisition of various pieces of information from the sensors in the control target devices 400 by communicating with the remote control devices 300. In other words, the programmable controller 200 is connected to the remote control devices 300a and 300b via a network 250 so as to enable network communication therebetween. The programmable controller 200 controls the remote control devices 300 such that the remote control devices 300 control the operations of the control target devices 400. Specifically, the programmable controller 200 controls the remote control device 300a such that the remote control device 300a controls the operations of the control target device 400a. Moreover, the programmable controller 200 controls the remote control device 300b such that the remote control device 300b controls the operations of the control target device 400b.

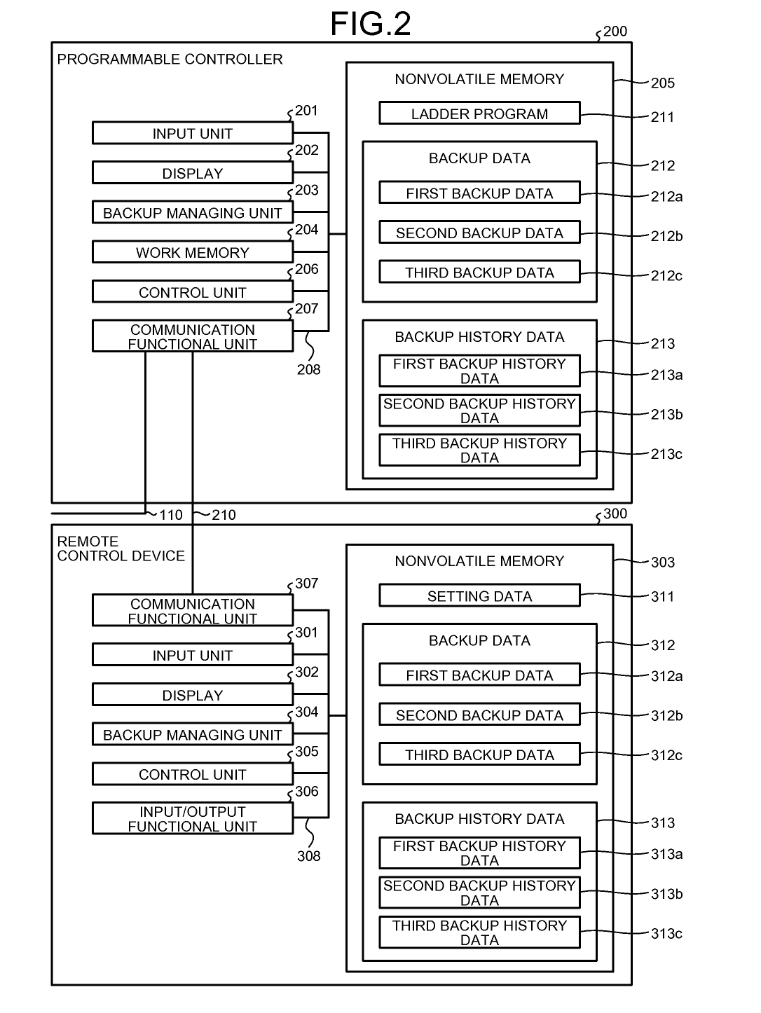

FIG. 2 is a block diagram illustrating the configurations of the programmable controller 200 and the remote control device 300 in the programmable controller system 10 according to the embodiment of the present invention.

The programmable controller 200 includes an input unit 201, which is an input unit from which various pieces of input information are input to the programmable controller 200, and a display 202, which is a display processing unit that displays various pieces of information stored in the programmable controller 200. The programmable controller 200 further includes a backup managing unit 203, which manages the backup data process performed on the internal data stored in the remote control devices 300, a work memory 204, which is a volatile storage unit, and a nonvolatile memory 205, which is a nonvolatile storage unit that stores therein backup data and backup history data for the internal data stored in the remote control devices 300. The programmable controller 200 further includes a control unit 206, which performs overall control of the processes performed by the programmable controller 200, and a communication functional unit 208, which communicates with the remote control devices 300.

A touch panel integral with the display 202 is, for example, used as the input unit 201. With the input information input from the input unit 201, the programmable controller 200 can control its own operations and can also control the remote control devices 300.

The display 202 can display information stored in the programmable controller 200 and information input from external devices. A liquid crystal display device is, for example, used as the display 202.

The work memory 204 is a volatile storage unit that temporarily stores therein a program that runs on the programmable controller 200 and information such as data processed by the program.

The nonvolatile memory 205 is a storage unit that stores therein various programs, such as a ladder program 211, which is input from the data creation device 100 and is used for causing the programmable controller 200 to control the remote control devices 300, and a program for operating the programmable controller 200 itself, various pieces of setting data input from the data creation device 100, various pieces of data, such as data created during processes performed by the programmable controller 200 and data input from the remote control devices 300. The data input from the remote control devices 300 includes backup data 212 and backup history data 213, which will be described later. Various storage devices, such as a hard disk drive and a semiconductor storage device, can be used as the nonvolatile memory 205.

The backup managing unit 203 outputs, to each of the remote control devices 300, i.e., the remote control device 300a and the remote control device 300b, backup instruction information instructing the remote control devices 300 to perform a backup process on the internal data stored in the remote control devices 300. The programmable controller 200 outputs backup instruction information to each remote control device 300a in accordance with instructions in the ladder program for performing a process of causing the remote control device 300a to control the control target device 400a. The programmable controller 200 outputs backup instruction information to each remote control device 300b in accordance with instructions in the ladder program for performing a process of causing the remote control device 300b to control the control target device 400b. The programmable controller 200 outputs backup instruction information to each of the remote control devices 300 as needed in accordance with the input information that is input from the input unit 201 by the user. The programmable controller 200 does not perform control of monitoring backup date and time at which the last backup process was completed and regularly outputting backup instruction information to each of the remote control devices 300.

When backup instruction information is input from the programmable controller 200, the remote control device 300 performs a backup process on the internal data in accordance with the backup instruction information. Then, after the remote control device 300 stores therein backup data and backup history data indicating the history of the backup process, which are created by performing the backup process, the remote control device 300 outputs the backup data and the backup history data to the programmable controller 200.

Backup data includes setting data for setting the operations of the entire remote control device 300 and for setting the operations for controlling the control target device 400 performed by an input/output functional unit 306, which will be described later. Backup history data is data on the date and time at which the backup data was created in the remote control device 300, i.e., data on the backup date and time at which the backup process was completed. The backup managing unit 203 receives the backup data and the backup history data output from the remote control device 300 via the communication functional unit 208 and stores them in the nonvolatile memory 205 as the backup data 212 and the backup history data 213.

FIG. 2 illustrates a state where first backup data 212a, second backup data 212b, and third backup data 212c are stored as the backup data 212. In this embodiment, the first backup data 212a is the oldest backup data and the third backup data 212c is the newest backup data.

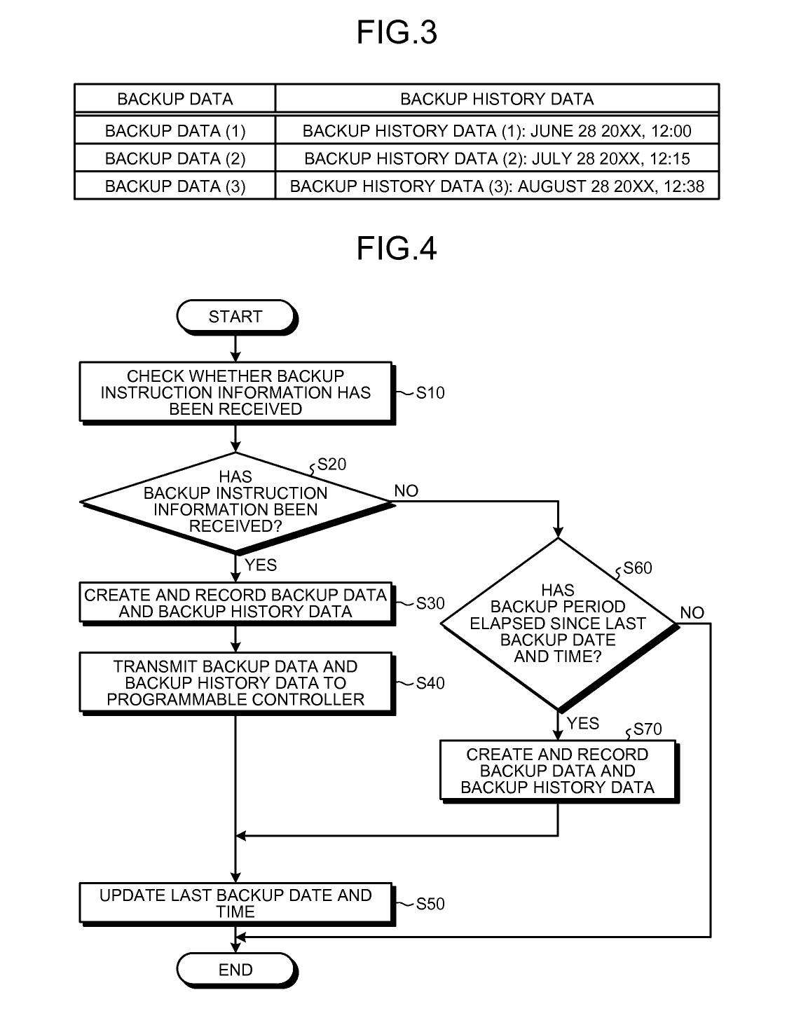

Moreover, FIG. 2 illustrates a state where first backup history data 213a, second backup history data 213b, and third backup history data 213c are stored as the backup history data 213. In this embodiment, the first backup history data 213a is the oldest backup history data and the third backup history data 213c is the newest backup history data. Backup data and backup history data can be managed in association with each other, for example, by using a table as illustrated in FIG. 3. Specifically, the first backup history data 213a is backup history data on the first backup data 212a. The second backup history data 213b is backup history data on the second backup data 212b. The third backup history data 213c is backup history data on the third backup data 212c.

In this embodiment, an example is illustrated where three pieces of backup data and three pieces of backup history data are stored in the nonvolatile memory 205; however, more pieces of backup data and backup history data are actually stored in the nonvolatile memory 205.

The control unit 206 performs overall control of the processes performed by the respective components in the programmable controller 200 including a process of the programmable controller 200 to control the remote control devices 300 such that the remote control devices 300 control the control target devices 400 and management of the backup process performed on the internal data stored in the remote control devices 300. The control unit 206 performs calculations using the ladder program in accordance with the operation result information input from the remote control devices 300 and outputs, to the remote control devices 300, remote-control-device control information for causing the remote control devices 300 to control the control target devices 400.

The communication functional unit 208 communicates with the data creation device 100 and the remote control devices 300 for transmitting and receiving data to and from the data creation device 100 and the remote control devices 300. The communication functional unit 208 analyzes the content of the communication data input from the data creation device 100 via the communication line 110 and distributes the communication data to other functional units in the programmable controller 200 if necessary. Moreover, the communication functional unit 208 analyzes the content of the communication data input from the remote control devices 300 via the network 250 and distributes the communication data to other functional units in the programmable controller 200 if necessary. Furthermore, the communication functional unit 208 receives data from other functional units in the programmable controller 200 and outputs the received data to the data creation device 100 or the remote control devices 300.

The respective components in the programmable controller 200 are connected to each other via an internal bus 208.

The remote control devices 300 are connected to the programmable controller 200 via the network 250 so as to enable network communication therebetween. The remote control devices 300 are connected to the control target devices 400 via communication lines 350 so as to enable data communication therebetween. The remote control devices 300 control the control target devices 400 in accordance with control performed by the programmable controller 200, i.e., the remote-control-device control information that is output by the programmable controller 200 executing the ladder program. Specifically, the remote control device 300a controls the control target device 400a and the remote control device 300b controls the control target device 400b.

The remote control device 300 includes an input unit 301, which is an input unit from which various pieces of input information are input to the remote control device 300, and a display 302, which is a display processing unit that displays various pieces of information stored in the remote control device 300. The remote control device 300 further includes a nonvolatile memory 303, which is a nonvolatile storage unit that stores therein backup data and backup history data, and a backup managing unit 304, which manages the backup data process performed on the internal data stored in the remote control device 300. The remote control device 300 further includes, in one housing, a control unit 305, which performs overall control of the processes performed by the remote control device 300, the input/output functional unit 306, which controls the control target device 400 and controls the process of capturing input information from the control target device 400, and a communication functional unit 307, which communicates with the programmable controller 200.

A touch panel integral with the display 302 is, for example, used as the input unit 301. With the input information input from the input unit 301, the programmable controller 200 can control its own operations.

The display 302 can display information stored in the remote control device 300 and information input from external devices. A liquid crystal display device is, for example, used as the display 302.

The nonvolatile memory 303 is a storage unit that stores therein a program for operating the remote control device 300 itself; a program for controlling the control target device 400; various pieces of setting data 311 input from the programmable controller 200; operation result information, such as a value from the sensor in the control target device 400, which is input from the control target device 400 and indicates the results of the operations performed by the control target device 400; and data created by performing the backup process. The setting data 311 includes setting data for setting the operations of the remote control device 300 itself and for setting the operations for controlling the control target device 400 performed by the input/output functional unit 306, which will be described later. One example of the operation result information includes detection data input to the remote control device 300 from the control target device 400, such as ON information or OFF information on the components in the control target device 400 and an analog value or the number of pulses detected by the sensor in the control target device 400. Another example of the operation result information includes data, such as ON information or OFF information on the components in the control target device 400, an analog value, and the number of pulses. This information is output to the control target device 400 from the remote control device 300 in order to instruct the control target device 400 to perform an operation with which the operation result information that is input to the remote control device 300 from the control target device 400 is created as described above. The data created by performing the backup process includes backup data 312 and backup history data 313, which will be described later. Various storage devices, such as a hard disk and a semiconductor storage device, can be used as the nonvolatile memory 303.

The backup managing unit 304 performs a backup process on the internal data stored in the remote control device 300, i.e., creates and stores backup data and backup history data, in accordance with the backup instruction information input from the programmable controller 200. Backup data includes setting data for setting the operations of the remote control device 300 itself and for setting the operations for controlling the control target device 400 performed by the input/output functional unit 306, which will be described later. These pieces of setting data are stored in the nonvolatile memory 303 and are used for the execution of a program for controlling the control target device 400.

In the remote control device 300, when backup instruction information is input to the communication functional unit 307 from the programmable controller 200, the backup instruction information is sent to the backup managing unit 304. The backup managing unit 304 performs a backup process on the internal data in accordance with the backup instruction information. The backup managing unit 304 normally performs a backup process on the internal data in accordance with the backup instruction information input from the programmable controller 200, i.e., using the backup instruction information as a trigger condition. Moreover, the backup managing unit 304 performs a backup process on the internal data as needed in accordance with the backup instruction information that is output from the programmable controller 200 in accordance with the input information that is input to the programmable controller 200 by the user.

The backup managing unit 304 stores, in the nonvolatile memory 303, the backup data and the backup history data indicating the history of the backup process, which are created by performing the backup process, as the backup data 312 and the backup history data 313, respectively. In response to the backup instruction information, the backup managing unit 304 associates the backup data 312 with the backup history data 313 and outputs them to the programmable controller 200 via the communication functional unit 307.

FIG. 2 illustrates a state where first backup data 312a, second backup data 312b, and third backup data 312c are stored as the backup data 312. In this embodiment, the first backup data 312a is the oldest backup data and the third backup data 312c is the newest backup data. The first backup data 312a and the first backup data 212a are the same data, the second backup data 312b and the second backup data 212b are the same data, and the third backup data 312c and the third backup data 212c are the same data.

Moreover, FIG. 2 illustrates a state where first backup history data 313a, second backup history data 313b, and third backup history data 313c are stored as the backup history data 313. In this embodiment, the first backup history data 313a is the oldest backup history data and the third backup history data 313c is the newest backup history data. The first backup history data 313a and the first backup history data 213a are the same data, the second backup history data 313b and the second backup history data 213b are the same data, and the third backup history data 313c and the third backup history data 213c are the same data.

Backup data and backup history data can be managed in association with each other, for example, by using a table as illustrated in FIG. 3. FIG. 3 is a schematic diagram illustrating one example of an association between backup data and backup history data in the programmable controller system 10 according to the present embodiment. Specifically, the first backup history data 313a is backup history data corresponding to the first backup data 312a. The second backup history data 313b is backup history data corresponding to the second backup data 312b. The third backup history data 313c is backup history data corresponding to the third backup data 312c. Such a table is stored in the nonvolatile memory 303 in a set with or separately from the backup data 312 or the backup history data 313.

In this embodiment, an example is illustrated where three pieces of backup data and three pieces of backup history data are stored in the nonvolatile memory 303; however, more pieces of backup data and backup history data are actually stored in the nonvolatile memory 303.

Even when backup instruction information is not input from the programmable controller 200, if a backup process has not been performed for a predetermined period of time, the backup managing unit 304 can automatically back up the internal data. When the backup managing unit 304 automatically backs up the internal data, created backup data and backup history data are not transmitted to the programmable controller 200 but are stored and managed only in the nonvolatile memory 303 of the remote control device 300.

The backup managing unit 304 records therein the newest backup history data, i.e., data on the backup date and time at which the backup process was completed, and manages the data. The newest backup history data managed in the backup managing unit 304 is updated every time a backup process is performed. As described above, when the backup managing unit 304 automatically backs up the internal data, the newest backup history data is used for calculating the elapsed time from the last backup process to the current time. Accordingly, the backup managing unit 304 can determine whether a backup process has not been performed for a predetermined period of time since the last backup process. Instead of managing the newest backup history data in the backup managing unit 304, it is also possible that the backup managing unit 304 refers to the newest backup history data stored in the nonvolatile memory 303 and calculates the elapsed time from the last backup process to the current time.

When the backup managing unit 304 determines that a backup process has not been performed for a predetermined period of time since the last backup process, the backup managing unit 304 can output, to the programmable controller 200, alarm information indicating that “a backup process has not been performed for a predetermined period of time” and display the alarm information on the display 202 of the programmable controller 200. Moreover, when the backup managing unit 304 determines that a backup process has not been performed for a predetermined period of time since the last backup process, the backup managing unit 304 can display, on the display 302, an alarm indicating that “a backup process has not been performed for a predetermined period of time”.

The backup managing unit 304 can output, to the network 250, the backup history data 313 stored in the nonvolatile memory 303. Accordingly, other master stations connected to the network 250 can obtain the backup history data in the remote control device 300 via the network 250 and refer to the backup history data, thus enabling the information to be shared.

The control unit 305 performs overall control of the respective components in the remote control device 300 including control of the control target device 400 with the remote control device 300 and management of the backup process of the internal data stored in the remote control device 300.

The input/output functional unit 306 outputs, to the control target device 400, control-target-device control information for controlling each control target device 400 in accordance with the remote-control-device control information output from the programmable controller 200. The input/output functional unit 306 outputs, to the control target device 400, the control-target-device control information in accordance with the remote-control-device control information by using a program (not illustrated) that is used for controlling the control target device 400 and is stored in the nonvolatile memory 303 and setting data that is set by being input from the programmable controller 200 and is used for setting the operations of the input/output functional unit 306.

When the input/output functional unit 306 is composed of a microcomputer, the input/output functional unit 306 writes the above-described setting data in the register of the microcomputer in accordance with the information on the output instruction to output the control-target-device control information. The information on the output instruction is included in the remote-control-device control information. Then, the input/output functional unit 306 outputs, to the control target device 400 from the output terminal of the remote control device 300, the control-target-device control information obtained through calculations using the setting data written in the register and the program for controlling the control target device 400.

Moreover, operation result information, such as a value from the sensor in the control target device 400, which indicates the results of the operations performed by the control target device 400, is input to the input/output functional unit 306 from the control target device 400. The input/output functional unit 306 outputs the input operation result information to the programmable controller 200 via the communication functional unit 307 and the communication line 350. In other words, the input/output functional unit 306 has a function of controlling the control target device 400 and a function of obtaining the operation result information on the control target device 400 and outputting it to the programmable controller 200. The input/output functional unit 306 may store the operation result information in the nonvolatile memory 303. The input/output functional unit 306 and the control target device 400 may directly communicate with each other via the communication line 350 or communicate with each other via the communication functional unit 307 and the communication line 350.

When the input/output functional unit 306 is composed of a microcomputer, operation result information input from the control target device 400 to the input terminal of the remote control device 300 is written in the register of the microcomputer. Then, the input/output functional unit 306 reads and obtains data on the operation result information from the register and outputs the data on the operation result information to the programmable controller 200 in accordance with the information on the read instruction to read the operation result information. The information on the read instruction is included in the remote-control-device control information.

The communication functional unit 307 communicates with the programmable controller 200 for transmitting and receiving data to and from the programmable controller 200. The method of communicating with the programmable controller 200 is not particularly limited. The communication functional unit 307 analyzes the content of the communication data input from the programmable controller 200 via the network 250 and distributes the communication data to other functional units in the remote control device 300 if necessary. When backup instruction information is input from the programmable controller 200, the communication functional unit 307 outputs the backup instruction information to the backup managing unit 304. Moreover, the communication functional unit 307 receives data from other functional units in the remote control device 300 and outputs the received data to the programmable controller 200.

The respective components in the remote control device 300 are connected to each other via an internal bus 308.

Next, the backup process performed by the backup managing unit 304 of the remote control device 300 will be explained with reference to FIG. 4. FIG. 4 is a flowchart describing the operation of the backup process performed by the backup managing unit 304 of the remote control device 300.

At Step S10, the backup managing unit 304 starts a process of checking whether backup instruction information output from the programmable controller 200 has been received. At Step S20, the backup managing unit 304 determines whether backup instruction information has been received.

At Step S20, when the backup managing unit 304 determines that backup instruction information has been received (Yes at Step S20), at Step S30, the backup managing unit 304 performs a backup process on the internal data stored in the remote control device 300, i.e., creates and records backup data and backup history data. Specifically, the backup managing unit 304 creates backup data and backup history data for the internal data and stores them in the nonvolatile memory 303 as the backup data 312 and the backup history data 313, respectively.

Next, at Step S40, in response to the backup instruction information, the backup managing unit 304 associates the backup data 312 with the backup history data 313 and outputs them to the programmable controller 200.

Next, at Step S50, the backup managing unit 304 updates the newest backup history data managed by the backup managing unit 304, i.e., data on the backup date and time at which the backup process was completed, to the backup history data recorded at Step S30, and then ends the series of processes.

In contrast, at Step S20, when the backup managing unit 304 determines that backup instruction information has not been received (No at Step S20), at Step S60, the backup managing unit 304 calculates the elapsed time from the last backup date and time to the current time and determines whether a predetermined backup period has elapsed since the last backup process. The backup period is determined by setting a time interval at which a backup process is to be performed when the backup managing unit 304 automatically performs a backup process. The backup period can be arbitrarily determined by the user and can be set in the backup managing unit 304 via the programmable controller 200.

At Step S60, when the backup managing unit 304 determines that the predetermined backup period has elapsed since the last backup date and time (Yes at Step S60), at Step S70, the backup managing unit 304 automatically performs a backup process on the internal data stored in the remote control device 300, i.e., automatically creates and records backup data and backup history data. Specifically, the backup managing unit 304 creates backup data and backup history data for the internal data and stores them in the nonvolatile memory 303 as the backup data 312 and the backup history data 313, respectively.

When the backup managing unit 304 automatically performs a backup process, the backup managing unit 304 records and manages the created backup data and backup history data only in the nonvolatile memory 303 of the remote control device 300. The backup managing unit 304 does not output the created backup data and backup history data to the programmable controller 200 as long as there is no request to do so from the programmable controller 200.

Next, at Step S50, the backup managing unit 304 updates the newest backup history data managed by the backup managing unit 304, i.e., data on the backup date and time at which the backup process was completed, to the backup history data recorded at Step S70, and then ends the series of processes.

When the backup managing unit 304 determines that the predetermined backup period has not elapsed since the last backup date and time at Step S60 (No at Step S60), the backup managing unit 304 ends the series of processes. By repeating the above processes, the backup managing unit 304 of the remote control device 300 can perform a backup process on the internal data stored in the remote control device 300.

In the above descriptions, a case has been explained where backup data and backup history data are stored in the nonvolatile memory 205 of the programmable controller 200 and the nonvolatile memories 303 of the remote control devices 300. As another form, the backup managing unit 203 and the backup managing unit 304 may be configured to include a nonvolatile memory and backup data and backup history data may be stored in the nonvolatile memory.

In the above descriptions, a case has been explained where two control target devices 400 are controlled by one programmable controller 200 via the remote control devices 300; however, the number of the control target devices 400 that are controlled is not limited to two. In other words, the configuration can be such that one control target device 400 is controlled by one programmable controller 200 via the remote control device 300. Alternatively, the configuration can be such that three or more control target devices 400 are controlled by one programmable controller 200 via the remote control devices 300.

Functions executed by the programmable controller 200 and the remote control devices 300 according to the above embodiment can be configured as a program in which the processing procedure of the functions is stored, and the functions can be realized by executing the program with a computer device that includes components such as a CPU and a storage device, as illustrated in FIG. 6.

FIG. 6 is a block diagram schematically illustrating an example of the configuration of a computer device 500 that can realize functions as the programmable controller 200 and the remote control devices 300 described above. As illustrated in FIG. 6, the computer device 500 has a configuration in which a display device 501, such as an LCD (Liquid Crystal Display), an input device 502, such as a keyboard, a CPU 503 for executing calculations, a nonvolatile memory 504, such as a ROM (Read Only Memory), a volatile memory 505, such as a RAM (Random Access Memory), a display memory 506, which stores therein display screens displayed on the display device 501, a communication interface 507, which communicates with external devices, and the like are connected to each other via an internal bus 508.

The program that is stored in the nonvolatile memory 504 and in which the processing procedure of the functions executed in the programmable controller 200 or the remote control devices 300 is written is loaded into the volatile memory 505 and is executed by the CPU 503. This program is recorded in a recording medium readable by the computer device, such as a hard disk, a CD (Compact Disk), a ROM (Read Only Memory), an MO (Magneto-Optical disk), and a DVD (Digital Versatile Disk or Digital Video Disk), or this program can be distributed via a computer network communication line, such as the Internet. In this case, the program is stored in the nonvolatile memory 504 from an information processing terminal connected via the communication interface 507.

In the programmable controller system 10 described above, backup data and backup history data for internal data including setting data for setting the operations of the remote control device 300 itself and for setting the operations of the input/output functional unit 306 are stored in the remote control device 300 itself. Accordingly, the same backup data and backup history data are stored in both the programmable controller 200, which is a master station, and the remote control device 300.

Depending on the purpose or situation of a restore, when a restore is performed with the backup data for the internal data stored in the remote control devices 300, it is possible to freely select whether a restore is performed with the backup data 212 managed in the programmable controller 200 or the backup data 312 managed in the remote control devices 300. Data with which a restore is performed can be selected and a restore can be performed, for example, by inputting instruction information into the programmable controller 200 from the data creation device 100. An explanation will be given of the applications of the backup data 212 stored in the programmable controller 200 and the backup data 312 stored in the remote control devices 300.

The backup data 212 stored in the programmable controller 200 is used when a restore is collectively performed on the internal data stored in the remote control devices 300 connected via the network 250. When a restore is performed on the internal data stored in a single remote control device 300, the backup data 312 stored in the remote control device 300 is used.

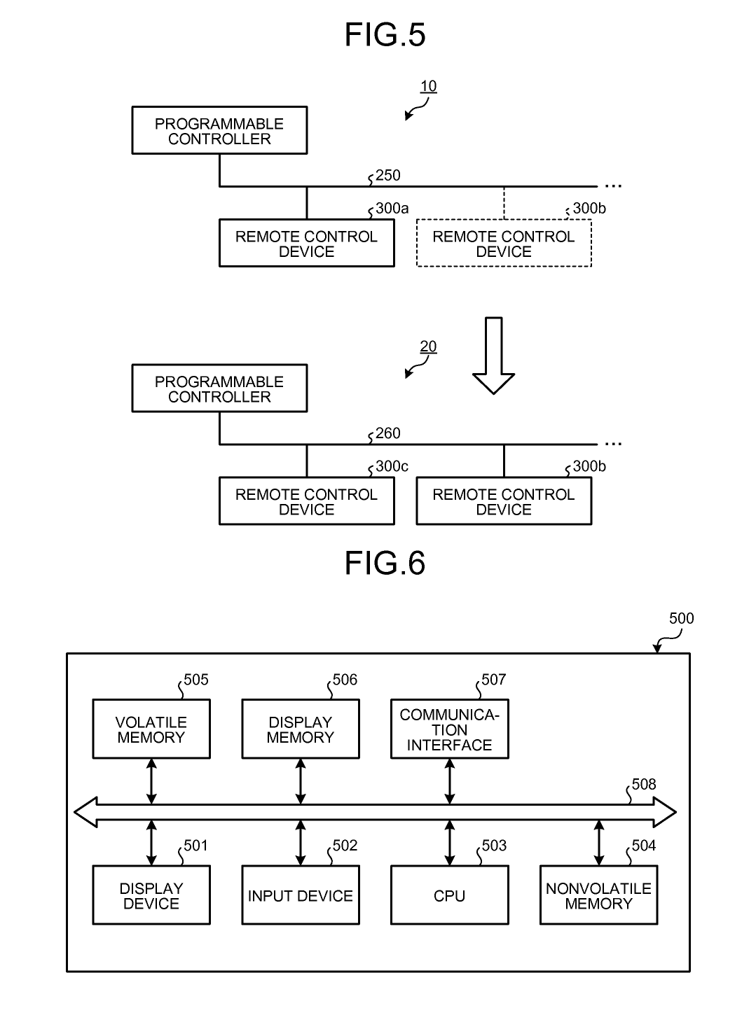

When the remote control device 300 is relocated from the programmable controller system in which the remote control device 300 is currently connected to a different programmable controller system that uses a different network, the backup data 312 stored in the remote control device 300 is used to cause the remote control device 300 to perform the same operations in the network to which the remote control device 300 is relocated as those performed before the relocation. For example, the backup data 312 stored in the remote control device 300b illustrates a case where the remote control device 300b is relocated from the programmable controller system 10, which is configured to use the network 250, to a programmable controller system 20, which is configured to use a network 260, which is different from the network 250, and to which a remote control device 300c is connected, as illustrated in FIG. 5. In this case, the backup data 312 stored in the remote control device 300b is used to cause the remote control device 300b to perform the same operations in the programmable controller system 20 to which the remote control device 300b is relocated as those performed before the relocation. FIG. 5 is a diagram explaining the relocation of the remote control device 300b. FIG. 5 illustrates a case where the remote control device 300b is relocated from the programmable controller system 10 to the programmable controller system 20. FIG. 5 does not illustrate control target devices.

In the programmable controller system 10 according to the present embodiment, backup data for the internal data stored in the remote control device 300 is recorded in the remote control device 300 itself. Thus, even when the remote control device 300 is relocated to a different programmable controller system configured to use a different network, only the remote control device 300 needs to be relocated. In other words, it is possible to eliminate the need to read backup data for the internal data stored in the remote control device 300 from the programmable controller 200 to an external storage device and the need to move the backup data from the external storage device to the remote control device 300 that is relocated to a different programmable controller system. Accordingly, it becomes easy to manage backup data when the remote control device 300 is relocated to a different programmable controller system. Moreover, it is possible to prevent occurrence of human errors, such as operator errors, when the remote control device 300 is relocated to a different programmable controller system. Therefore, it is possible to prevent an increase in the downtime of the programmable controller system due to relocation of the remote control device 300 and thus the programmable controller system can be efficiently operated.

Moreover, in the backup managing unit 203 of the programmable controller 200, a plurality of pieces of the backup data 212 and a plurality of pieces of the backup history data 213 stored in the nonvolatile memory 205 can be managed. In the backup managing unit 304 of the remote control device 300, a plurality of pieces of the backup data 312 and a plurality of pieces of the backup history data 313 stored in the nonvolatile memory 303 can be managed. Therefore, it is possible to retroactively select backup data with which a restore is performed by referring to the backup history data 213 or the backup history data 313.

With the conventional technologies, when a backup process needs to be performed regularly on the internal data stored in the remote control devices 300, it is necessary to create, for each of the remote control devices 300, a ladder program for checking whether a predetermined period of time has elapsed since the backup date and time at which the last backup process was completed and instructing the remote control device 300 to perform a backup process, on the programmable controller 200. Therefore, man-hours for creation and maintenance of the ladder programs increase, which increases the load on the user.

In contrast, with the programmable controller system 10 according to the present embodiment, backup history data, i.e., data on the backup date and time at which the backup process was completed, is recorded in the remote control devices 300 together with backup data. The remote control devices 300 can automatically perform a backup process on the internal data on the basis of the elapsed time from the last backup process by using the backup history data stored in the remote control devices 300 themselves.

In other words, backup history data indicating the execution of a backup process of the internal data stored in the remote control devices 300 is stored in the remote control devices 300 themselves; therefore, when a backup process is not performed for a predetermined period of time, the remote control devices 300 themselves can regularly perform a backup process on the internal data automatically by using the lapse of a predetermined backup period as a trigger condition. Therefore, it is not necessary for the programmable controller 200 to monitor the elapsed time from the last backup date and time and thus man-hours for creation and maintenance of the ladder programs for regularly performing a backup process are eliminated, thereby reducing the load on the user.

As described above, by storing, in the remote control device 300 itself, backup and backup history data for the internal data stored in the remote control device 300, the backup data for the internal data can be managed by a single remote control device and it becomes easy to manage the internal data when the remote control device is relocated to a programmable controller system that is different from the programmable controller system in which the remote control device is currently disposed, thereby reducing the load on the user.

The configurations illustrated in the above embodiment are examples of the content of the present invention and the configurations can be combined with other publicly known technologies and part of the configurations can be omitted or changed without departing from the scope of the present invention.

### REFERENCE SIGNS LIST

10, 20 programmable controller system, 100 data creation device, 110 communication line, 200 programmable controller, 201, 301 input unit, 202, 302 display, 203, 304 backup managing unit, 204 work memory, 205, 303, 504 nonvolatile memory, 206, 305 control unit, 207 communication functional unit, 208, 308, 508 internal bus, 211 ladder program, 212, 312 backup data, 213, 313 backup history data, 250, 260 network, 300, 300a, 300b, 300c remote control device, 306 input/output functional unit, 307 communication functional unit, 350 communication line, 400, 400a, 400b control target device, 500 computer device, 501 display device, 502 input device, 503 CPU, 505 volatile memory, 506 display memory, 507 communication interface.

1.-9. (canceled)

10. A remote control device that is communicatively connected to a control device and a control target device and controls an operation of the control target device in accordance with a control performed by the control device, the remote control device comprising, in one housing:
a communication functional unit to communicate with the control device;
an input/output functional unit to output control-target-device control information for controlling an operation of the control target device to the control target device on a basis of remote-control-device control information, which is output from the control device and is used for controlling the remote control device, and to receive operation result information, which is output from the control target device and indicates an operation result of the control target device that operates on a basis of the remote-control-device control information;
a backup managing unit to create backup data for internal data stored in the remote control device and create backup history data that is data on date and time at which the backup data is created; and
a nonvolatile storage unit to associate the backup history data with the backup data and store the backup data and the backup history data, wherein
when the backup data has not been created even after an elapsed time from date and time of newest backup history data exceeds a predetermined period of time, the backup managing unit automatically creates the backup data and the backup history data.

11. A remote control device that is communicatively connected to a control device and a control target device and controls an operation of the control target device in accordance with a control performed by the control device, the remote control device comprising, in one housing:
a communication functional unit to communicate with the control device;
an input/output functional unit to output control-target-device control information for controlling an operation of the control target device to the control target device on a basis of remote-control-device control information, which is output from the control device and is used for controlling the remote control device, and to receive operation result information, which is output from the control target device and indicates an operation result of the control target device that operates on a basis of the remote-control-device control information;
a backup managing unit to create backup data for internal data stored in the remote control device and create backup history data that is data on date and time at which the backup data is created; and
a nonvolatile storage unit to associate the backup history data with the backup data and store the backup data and the backup history data, wherein
when the backup data has not been created even after an elapsed time from date and time of newest backup history data exceeds a predetermined period of time, the backup managing unit outputs alarm information to the control device.

12. The remote control device according to claim 10 wherein
the communication functional unit is connected to the control device via a network, and
a master station that is connected to the network and is other than the control device is capable of obtaining the backup history data via the network.

13. The remote control device according to claim 11 wherein
the communication functional unit is connected to the control device via a network, and
a master station that is connected to the network and is other than the control device is capable of obtaining the backup history data via the network.

14. The remote control device according to claim 10, wherein the internal data is setting data for setting an operation of the remote control device.

15. The remote control device according to claim 11, wherein the internal data is setting data for setting an operation of the remote control device.

16. The remote control device according to claim 14, wherein the internal data is setting data for setting an operation of the input/output functional unit.

17. The remote control device according to claim 15, wherein the internal data is setting data for setting an operation of the input/output functional unit.

18. The remote control device according to claim 10, wherein the backup managing unit outputs, to the control device, the backup data and the backup history data in association with each other.

19. A control system comprising:
a control target device;
a remote control device to control an operation of the control target device, the remote control device being communicatively connected to the control target device; and
a control device to perform a control of causing the remote control device to control an operation of the control target device, the control device being communicatively connected to the remote control device, wherein
the remote control device includes, in one housing,
a communication functional unit to communicate with the control device,
an input/output functional unit to output control-target-device control information for controlling an operation of the control target device to the control target device on a basis of remote-control-device control information, which is output from the control device and is used for controlling the remote control device, and to receive operation result information, which is output from the control target device and indicates an operation result of the control target device that operates on a basis of the remote-control-device control information,
a backup managing unit to create backup data for internal data stored in the remote control device and create backup history data that is data on date and time at which the backup data is created, and
a nonvolatile storage unit to associate the backup history data with the backup data and store the backup data and the backup history data, and
when the backup data has not been created even after an elapsed time from date and time of newest backup history data exceeds a predetermined period of time, the backup managing unit automatically creates the backup data and the backup history data.

20. A control system comprising:
a control target device;
a remote control device to control an operation of the control target device, the remote control device being communicatively connected to the control target device; and
a control device to perform a control of causing the remote control device to control an operation of the control target device, the control device being communicatively connected to the remote control device, wherein
the remote control device includes, in one housing,
a communication functional unit to communicate with the control device,
an input/output functional unit to output control-target-device control information for controlling an operation of the control target device to the control target device on a basis of remote-control-device control information, which is output from the control device and is used for controlling the remote control device, and to receive operation result information, which is output from the control target device and indicates an operation result of the control target device that operates on a basis of the remote-control-device control information,
a backup managing unit to create backup data for internal data stored in the remote control device and create backup history data that is data on date and time at which the backup data is created, and
a nonvolatile storage unit to associate the backup history data with the backup data and store the backup data and the backup history data, and
when the backup data has not been created even after an elapsed time from date and time of newest backup history data exceeds a predetermined period of time, the backup managing unit outputs alarm information to the control device.
